(19) United States
(12) Patent Application Publication
(10) Pub. No.: US 2011/0064937 A1
(43) Pub. Date: Mar. 17, 2011

(54) COMPOSITION FOR PRECIOUS METAL SINTERING, PROCESS FOR PRODUCING PRECIOUS METAL SINTER AND PRECIOUS METAL SINTER

(75) Inventors: Seigo Mukoyama, Tokyo (JP); Masaki Tanaka, Tokyo (JP); Tomoaki Kasukawa, Tokyo (JP)

(73) Assignee: Aida Chemcial Industries Co. Ltd, Tokyo (JP)

(21) Appl. No.: 12/736,780

(22) PCT Filed: May 28, 2008
(86) PCT No.: PCT/JP2008/059845

§ 371 Date: Nov. 9, 2010

(51) Int. Cl. B32B 3/26; C22C 1/08; B22F 3/11

(52) U.S. Cl. 428/312.6; 75/252; 419/2

(57) ABSTRACT

A composition for precious metal sintering that yields a precious metal sinter for use in jewelry, ornaments, accessories, etc., by sintering, especially that realizes not only production of a precious metal sinter even when the precious metal content per volume of the composition for precious metal sintering is reduced but also in a striking reduction of the weight of the precious metal sinter. Further, there are disclosed a process for producing the precious metal sinter and the precious metal sinter. This composition for precious metal sintering is characterized by comprising a mixture of precious metal powder, hollow glass powder and organic binder solution.

### BACKGROUND OF THE INVENTION

1. Field of the Invention

The present invention relates to a composition for precious metal sintering from which a precious metal sinter for use in jewelry, ornaments, accessories, or the like can be obtained. More specifically, the present invention relates to: a composition for precious metal sintering; a process for producing the precious metal sinter; and the precious metal sinter. The composition for precious metal sintering can obtain a precious metal sinter even if the precious metal content per unit volume of the composition for precious metal sintering is reduced, which can reduce weight of the precious metal sinter.

2. Description of the Prior Art

It is well known that there exists a composition for precious metal sintering (which may also be referred to as a precious metal clay-like composition or a precious metal plastic composition) containing a precious metal powder and an organic binder as fundamental components. The composition for precious metal sintering is heated-sintered after shaping into a prescribed shape and dried, and thereby the organic binder is removed by being decomposed, vaporized, combusted, or the like from the composition for precious metal sintering during firing. This induces cohesion of the particles of the precious metal powder to be sintered to each other, allowing the production of a desired precious metal sinter. Herein, the precious metal sinter obtained from the above-described composition for precious metal sintering is porous in itself and thus weighs less compared to a molded metal object produced by casting or the like (a weight reduction of up to about 40% is possible compared to a cast object). Accordingly, the precious metal sinter is suitable to be used for ornament to be put on (see, for example, Patent Documents 1 to 6).

On the other hand, reduction in weight of made objects in many fields has been studied and implemented. It is known that a reduction in weight of concrete products can be achieved by using concrete produced by arranging cement concrete around an aggregate so as to increase porosity, or by adding lightweight aggregate such as pearlite and vermiculite to cement mortar.

It has also been known that reduction in weight of various plastic products can be achieved by adding a lightweight filling material such as silicon dioxide (silica) to resin.

However, techniques for concrete products or plastic products are not applicable in the field of producing a precious metal sinter using the composition for precious metal sintering. This is because a concrete product is solidified by cement solidification (hydraulic reaction system) in which the aggregate is taken into a matrix. This is a fundamental reaction system completely different from that in producing a precious metal sinter where precious metal powder is sintered at high temperature. A plastic product is produced by solidifying resin. This is also a fundamental reaction system completely different from that in producing a precious metal sinter whereby precious metal powder is sintered at high temperature.

Further, pearlite, vermiculite, or the like is not applicable to precious metal sinter obtained from the composition for precious metal sintering, unless the pearlite, vermiculite, or the like is made into fine powder. However, pearlite, vermiculite, or the like cannot possibly be applicable to the production of the precious metal sinter because the fine powder thereof is expected to have a larger apparent density and also to cause loss of the unique precious metallic coloring of the precious metal sintered product.

Further, in case that the precious metal content per unit volume of the composition for precious metal sintering is greatly reduced by adding a large amount of the lightweight filling material, it is not clearly known whether or not a successful precious metal sinter can be obtained therefrom. Moreover, the addition of the lightweight filling material disadvantageously degrades recognition as a precious metal product, due to the precious metal sintered product having essentially in itself a visual (aesthetic) value such as color and luster unique to precious metal.

In the meantime, in the field of producing a product by casting or the like, a core mold is used for creating a hollow object in some cases. In producing a product having a s complicated shape such as an ornament, however, it is difficult to use a core mold.

A core mold is sometimes used for creating a hollow in obtaining a sinter from the composition for precious metal sintering. However, the shape of such a core mold is inevitably limited because the core mold is to be burned down during firing/sintering, resulting in violent gas generation due to combustion. For example, assume a case where cork is used as a core mold, and the composition for precious metal sintering with a thickness thereof reduced is attached (applied) to the entire surface of the cork. If the object to be sintered is small-sized or has a gas vent hole, there is no problem. However, if the object is completely coated and sealed, there is a problem that the sintered object becomes deformed owing to the pressure of the gas during firing/sintering.

If a composition for precious metal sintering containing a silver oxide powder is sintered, a porous sinter can be obtained because the silver oxide powder is decomposed during firing, generating oxygen gas. Therefore, there is a problem that an obtained sinter becomes deformed due to pressure of the oxygen gas releasing during firing/sintering as described above (see, for example, Patent Document 7).

[Patent Document 1] Japanese Patent No. 3867786

[Patent Document 2] Japanese Patent No. 3456644

[Patent Document 3] Japanese Patent No. 3248505

[Patent Document 4] Japanese Patent No. 3896181

[Patent Document 5] Japanese Patent Application Publication No. 2002-241802

[Patent Document 6] Japanese Patent Application Publication No. 2007-51331

[Patent Document 7] Japanese Patent Application Publication No. 2004-292894

### SUMMARY OF THE INVENTION

The present invention has been made in an attempt to provide: a composition for precious metal sintering capable of obtaining a precious metal sinter even if the precious metal content per unit volume of the composition for precious metal sintering is reduced, and also capable of reducing the weight of the precious metal sinter object while maintaining a visual (aesthetic) value; a process for producing the precious metal sinter; and the precious metal sinter.

According to the first aspect of the present invention, a composition for precious metal sintering includes: a precious metal powder; an organic binder solution; and a hollow glass powder, and is suitable for manual shaping. The composition for precious metal sintering has a volume ratio of a bulk volume of the hollow glass powder in the range of 5 to 160% with respect to a total volume of the composition for precious metal sintering. The bulk volume of the hollow glass powder is measured in a state where the hollow glass powder exists independently without any other components.

The inventors have made intensive studies for solving the above-mentioned problems to finally find and achieve the present invention which provides a composition for precious metal sintering capable of obtaining a precious metal sinter even if the precious metal content per unit volume of the composition for precious metal sintering is reduced, and also capable of reducing the weight of the precious metal sinter while maintaining a visual (aesthetic) value, by mixing a hollow glass powder into the composition for precious metal sintering.

In the first aspect of the present invention, the composition for precious metal sintering can be handled similarly to a composition for precious metal sintering according to conventional technology but without decreasing ease of use and enables to obtain therefrom a precious metal sinter having much less weight while maintaining its visual value.

According to the second aspect of the present invention, a composition for precious metal sintering includes: a precious metal fundamental composition consisting of a 50 to 99 wt % of a precious metal powder and a 1 to 50 wt % of an organic binder solution; and a hollow glass powder contained in the precious metal fundamental composition, and is suitable for manual shaping. The composition for precious metal sintering has a volume ratio of a bulk volume of the hollow glass powder in the range of 5 to 160% with respect to a total volume of the composition for precious metal sintering. The bulk volume of the hollow glass powder is measured in a state where the hollow glass powder exists independently without any other components.

Also with a configuration as described above, the composition for precious metal sintering can be handled similarly to a conventional composition for precious metal sintering according to conventional technology without decreasing ease of handling and enables to obtain therefrom a precious metal sinter having much less weight while maintaining its visual value.

The terms “bulk volume” used in the first or second aspect of the present invention refer to the volume measured in such a way of, for example, putting a hollow glass powder into a measuring cylinder and measuring its volume with the scale of the measuring cylinder. The bulk volume thus includes a volume of the powder itself as well as that of interspace between particles of the powder and between a particle and the inside wall surface of the measuring cylinder. Therefore, the volume ratio of a bulk volume of the hollow glass powder in the range of 5 to 160% with respect to a total volume of the composition for precious metal sintering in which the bulk volume of the hollow glass powder is measured in a state where the hollow glass powder exists independently without any other components can be expressed by:

(a bulk volume of a hollow glass powder added/an actual volume of a total composition)×100=5 to 160%. The calculated result may exceed 100% because the “bulk volume” of the hollow glass powder added is used.

In general, when two different powders having different particle sizes from each other (for example, a precious metal powder and a hollow glass powder) are mixed together, a bulk volume of the mixed powder is smaller than a sum of respective bulk volumes of the two different powders. This is because, in the mixed powder, the smaller particle of one powder is crammed between larger particles of the other, which increases the bulk density of the mixed powder. Thus, in the present invention, an actual volume of an entire composition corresponds to an actual volume of the composition for precious metal sintering in which at least the precious metal powder, the hollow glass powder, and the organic binder solution are mixed together. Since the bulk volume of the added hollow glass powder is compared to the above actual volume, the bulk volume may exceed 100%.

Such a definition on the actual volume as above-mentioned has been made because the bulk density of the precious metal powder or the hollow glass powder varies according to a shape or a state thereof, and even if either one of a wt % or a vol % is used in the explanation, the actual desired conditions of the present invention cannot be clearly shown.

According to the third aspect, in the preferred embodiment of the present invention, the composition for precious metal sintering according to the first or second aspect includes the hollow glass powder having a mean particle diameter from 15 to 65 μm and the precious metal powder having a mean particle diameter from 1.0 to 20 μm, and is suitable for manual shaping.

The terms “mean particle diameter” of the precious metal powder used in the present invention are also referred to as an average grain diameter, an average particle diameter, a median diameter, a median size, or a 50% particle size; are typically represented as “D50”; and means a particle size corresponding to 50% of a cumulative distribution curve. More specifically, the mean particle diameter is a value of D50 of a particle size distribution obtained by using a laser diffraction-type particle size distribution measurement device with tri-laser scattered light detection mechanism (manufactured by Microtrac, Inc.) and setting measurement conditions thereof at “particle permeability: reflection” and “spherical/nonspherical: nonspherical”.

On the other hand, a definition of the terms “mean particle diameter” which describes the hollow glass powder of the present invention is the same as that of the precious metal powder previously explained. However, the measurement conditions of the laser diffraction-type particle size distribution measurement device with tri-laser scattered light detection mechanism (manufactured by Microtrac, Inc.) is set at “particle permeability: permeable, particle refractive index: a refractive index of the hollow glass powder to be measured” and “spherical/nonspherical: spherical”.

In a more preferable aspect, the precious metal,powder used is a mixed powder, 30 to 70 wt % of which consists of a powder having a mean particle diameter from 2.2 to 3.0 μm, and the reminder of which consists of a powder having a mean particle diameter from 5 to 20 μm.

The hollow glass powder is a glass powder which consists of particles each having a hollow inside. A bulk density of the hollow glass powder used herein is preferably from 0.075 to 0.38 g/cm³. The hollow glass powder has a mean particle diameter (D50) from 15 to 65 μm as described above. It is preferable to use the hollow glass powder in which a particle diameter at 10% value (D10) of cumulative volume counting from a smaller particle size in a particle size distribution is in the range of 5 to 30 μm; and, at 90% value (D90) of cumulative volume, from 20 to 110 μm.

According to the fourth aspect of the present invention, the composition for precious metal sintering according to the first or second aspect has a maximum measurement value of a pushing load from 0.08 to 1.13 N, if measured by: filling a 2-ml syringe having an inner diameter of 6 mm, an outlet inner diameter of 1.3 mm, and an outlet inner length of 8.3 mm with 1 ml of the composition for precious metal sintering; pushing a plunger of the syringe 10 mm at a speed of 17 mm/minute; and extruding the composition for precious metal sintering from an outlet of the syringe, and the composition for precious metal sintering having the maximum measurement value of a pushing load in the described range above is suitable for manual shaping.

The maximum measurement value of a syringe pushing load is influenced by a size, a shape, and the like of the precious metal powder and the hollow glass powder. Moreover, it is convenient that the maximum measurement value of a syringe pushing load varies according to a type, a combination, a solvent content, or the like of the organic binder, as well as a combination ratio of the precious metal powder, the hollow glass powder, and the organic binder solution. Therefore, the maximum measurement value of a syringe pushing load has been found as a comprehensive indicator for the composition for precious metal sintering, thus allowing the present invention to be achieved.

A 2-ml syringe [product name: JMS syringe 2-ml without needle (micro), manufactured by JMS Co., Ltd.] having an inner diameter of 6 mm, an outlet inner diameter of 1.3 mm, an outlet inner length of 8.3 mm is preferably used.

The composition for precious metal sintering according to the fourth aspect of the present invention is suitable and excellent in shapability if the maximum measurement value of a syringe pushing load of the composition for precious metal sintering is in the range of 0.08 to 1.13 N.

According to the fifth aspect of the present invention, the composition for precious metal sintering according to the fourth aspect, if having a clay-like plasticity, has the maximum measurement value of the syringe pushing load of from 0.24 to 1.13 N, and is suitable for manual shaping.

In the fifth aspect of the present invention, the composition for precious metal sintering having the maximum measurement value of the pushing load in the range of 0.24 to 1.13 N has plasticity especially suitable for manual shaping like ordinary clay and has excellent characteristics in shapability.

According to the sixth aspect of the present invention, the composition for precious metal sintering according to the fourth aspect, if shaped by being extruded from a syringe to make a three dimensional shape, has the maximum measurement value of a syringe pushing load of from 0.08 to 0.23 N when the composition for precious metal sintering within the syringe is extruded, and is suitable for manual shaping.

In the sixth aspect of the present invention, the composition for precious metal sintering having the maximum measurement value of the pushing load in the range of 0.08 to 0.23 N is suitable for representing a delicate line pattern. This means that the composition for precious metal sintering filled in a syringe, at a tip of which is set a fine nozzle, can be easily extruded in a filament shape or a string shape by manually pressing the plunger (piston) of the syringe.

According to the seventh aspect of the present invention, a process for producing a precious metal sinter includes the steps of: shaping the composition for precious metal sintering according to the first or second aspect; drying the shaped object; and sintering the dried shaped object to obtain the precious metal sinter.

In the seventh aspect of the process for producing a precious metal sinter, the composition for precious metal sintering according to the first or second aspect of the present invention can be shaped, dried, and sintered in a similar way to a process of producing a precious metal sinter according to conventional technology, because the composition for precious metal sintering of the present invention does not lose ease of handling such as shapability. The composition for precious metal sintering of the present invention also enables to obtain a precious metal sinter having much less weight while maintaining a visual value.

According to the eighth aspect of the present invention, a precious metal sinter is produced by the process according to the seventh aspect.

In the eighth aspect of the present invention, the precious metal sinter including the hollow glass powder therein weighs much less than a precious metal sinter made according to the conventional technology, and maintains a visual value similarly to a precious metal sinter according to conventional technology.

A composition for precious metal sintering of the present invention: can drastically reduce a precious metal content per unit volume in the composition for precious metal sintering; has easiness of handling such as shapability, similarly to a composition for precious metal sintering according to the conventional technology; and can obtain a precious metal sinter which is reduced by about 60 wt % compared to a precious metal sinter without containing any hollow glass powder according to the conventional technology.

The obtained precious metal sinter has a visual (aesthetic) value similar to a precious metal sinter made with conventional technology and is suitable for use in a relatively large-sized ornament, which cannot be made using a composition for precious metal sintering without containing a hollow glass powder according to the conventional technology, because the conventional composition for precious metal sintering is too heavy.

Further, the composition for precious metal sintering of the present invention itself is light, thus improving workability especially in producing a large-sized artistic craft.

Further, even if an added weight of the hollow glass powder is very small, a used amount of the precious metal powder can be greatly reduced, because a density of the hollow glass powder is remarkably small. This results in a large reduction in cost. For example, a used amount of silver can be reduced by about 60 wt %.

### BRIEF DESCRIPTION OF THE DRAWINGS

FIG. 1 is a side elevational view of a syringe pushing load measurement device according to the embodiment of the present invention.

FIG. 2 is a SEM image (×1000) of a precious metal sinter which has been sintered at 650° C. for 30 minutes according to the embodiment of the present invention.

FIG. 3 is a SEM image (×5000) of the precious metal sinter which has been sintered at 650° C. for 30 minutes according to the embodiment of the present invention.

FIG. 4 is a SEM image (×1000) of a precious metal sinter which has been sintered at 800° C. for 30 minutes according to the embodiment of the present invention.

FIG. 5 is a SEM image (×5000) of the precious metal sinter which has been sintered at 800° C. for 30 minutes according to the embodiment of the present invention.

### DESCRIPTION OF THE PREFERRED EMBODIMENT

A composition for precious metal sintering of the present invention includes: a precious metal powder; an organic binder solution, and a hollow glass powder.

The precious metal powder herein refers to a pure precious metal powder of Au, Ag, Pt, Pd, Rh, Ru, Ir, Os, or the like, or a precious metal alloy powder having one or more those elements as a major component. The particle size of the precious metal powder is not specifically limited. However, it is preferable to use a precious metal powder having a mean particle diameter from 1.0 to 20 μm, a maximum particle size of about 60.0 μm, and a minimum particle size of about 0.3 μm and to control a particle size distribution such that a sintering temperature thereof is from 600 to 900° C. For example, in a more preferable aspect, a mixed powder is used, 30 to 70 wt % of which consists of a powder having a mean particle diameter from 2.2 to 3.0 μm, and the reminder of which consists of a powder having a mean particle diameter from 5 to 20 μm.

The terms “mean particle diameter” herein are also referred to as an average grain diameter, an average particle diameter, a median diameter, a median size, or a 50% particle size; are typically represented as “D50”; and mean a particle size corresponding to 50% of a cumulative distribution curve. More specifically, the mean particle diameter is a value of D50 of a particle size distribution obtained by using a laser diffraction-type particle size distribution measurement device with tri-laser scattered light detection mechanism (manufactured by Microtrac, Inc.) and setting measurement conditions thereof at “particle permeability: reflection” and “spherical/nonspherical: nonspherical”.

The method of producing the precious metal powder is not specifically limited. However, it is preferable to produce a precious metal powder whose particles are nearly spherical.

In the case that particles of the powder included in the composition for precious metal sintering are not spherical but anisotropic, if the composition is extruded from, for example, a syringe or the like to form a bar-shaped object, inner and outer portions of the bar object are extruded at different speeds and consequently the particles tend to be oriented along a flow generated by the different speeds. This means that the inner and the outer portions of the composition for precious metal sintering including the particles behave differently when shrinking upon drying or sintering, which may cause a defect.

On the other hand, if particles of the powder included in the composition for precious metal sintering are nearly spherical, the powder tends to be densified. This allows the powder to be sintered at a lower temperature or for a shorter period of time. Further, the composition including the powder has a higher fluidity similar to clay, thus facilitating the operation of shaping such as bending and spreading.

Manufacturing Methods including gas atomization, water atomization, oxidation-reduction method, and gas phase method make it possible to obtain a precious metal powder having substantially spherical particles.

The hollow glass powder is a glass powder which has a hollow inside. Hollow glass powder having a bulk density from 0.075 to 0.38 g/cm³ is preferable. The hollow inside is preferable in a reduced atmospheric pressure condition.

The hollow glass powder has a mean particle diameter (D50) from 15 to 65 μm. It is preferable to use the hollow glass powder in which a particle diameter is at a 10% value (D10) of cumulative volume counting from a smaller particle size, particle size distribution is in the range of 5 to 30 μm; at a 90% value (D90) of, cumulative volume, from 20 to 110 μm; and, at a 95% value (D95) of cumulative volume, from 25 to 120 μm.

Note that the definition of the above “mean particle diameter” of the hollow glass powder is the same as that of the precious metal powder previously explained. However, the measurement conditions of the laser diffraction-type particle size distribution measurement device with tri-laser scattered light detection mechanism (manufactured by Microtrac, Inc.) are set at “particle permeability: permeable, particle refractive index: a refractive index of the hollow glass powder to be measured” and “spherical/nonspherical: spherical”.

The hollow glass powder is preferably made of, for example, soda-lime borosilicate glass (major components: SiO₂, CaO, Na₂O, and B₂O₃), borosilicate glass, sodium borosilicate glass, aluminosilicate glass, or the like. The hollow glass powder preferably has a softening point of 550° C. or higher. Such a hollow glass powder is commercially available under a product name of, for example, Glass Bubbles (manufactured by Sumitomo 3M Ltd.), CEL-STAR (manufactured by Tokai Kogyo Co., Ltd.), Q-CEL (manufactured by PQ Australia Pty. Ltd.), and Extendospheres (manufactured by Sphere One, Inc.).

The organic binder solution includes an organic binder, a solvent, and, if necessary to be added, an organic additive mixable with the solvent.

The organic binder usable in this invention is not to be considered limited to, however, but may include one or more members selected from the following: a cellulose-based binder such as methylcellulose, ethylcellulose, hydroxyethylcellulose, hydroxypropylcellulose, hydroxypropylmethylcellulose, and carmellose (carboxymethylcellulose); an alginic acid-based binder such as sodium alginate; a polysaccharide-based binder such as starch, wheat flour, British gum, xanthane gum, dextrin, dextran, and pullulan; an animal-derived binder such as gelatin; a vinyl-based binder such as polyvinyl alcohol and polyvinylpyrrolidone; an acryl-based binder such as polyacrylic acid and polyacrylate ester; and other resin-based binder such as polyethylene oxide, polypropylene oxide, and polyethylene glycol, etc.

One or more of the above organic binders are preferably selected and used herein. If the cellulose-based binder is used, a water-soluble cellulose-based binder is most preferably used.

Of the organic binders, the water-soluble cellulose-based binder gives plasticity to the composition for precious metal sintering. The polyethylene oxide gives a high viscosity at a low concentration and increases adhesiveness in its liquid form. The sodium alginate gives an appropriate level of water retentivity, similarly to glycerin and also helps increase adhesiveness. The polyacrylate ester and polyacrylic acid further increases adhesiveness.

Further, one or more organic additives mixable with the solvent as described above may be added to the organic binder solution where necessary.

The organic additive includes one or more members selected from the following: organic acid (oleic acid, stearic acid, phthalic acid, palmitic acid, sebacic acid, acetylcitric acid, hydroxybenzoic acid, lauric acid, myristic acid, caproic acid, enanthic acid, butyric acid, capric acid); organic acid ester such as n-dioctyl phthalate and n-dibutyl phthalate (organic acid ester having a methyl group, ethyl group, propyl group, butyl group, octyl group, hexyl group, dimethyl group, diethyl group, isopropyl group, and isobutyl group); higher alcohol (octanol, nonanol, decanol); polyol (glycerin, arabite, sorbitan, diglycerin, isoprene glycol, 1,3-butylene glycol); ether (dioctyl ether, didecyl ether); lignin which may be cited as a concrete example of the reticular macromolecular substance that results from the condensation of the component unit having phenylpropane as a backbone; liquid paraffin; and oil, or the mixture thereof (for example, olive oil containing rich oleic acid), etc.

The organic additive is added so as to improve plasticity or prevent a composition for precious metal sintering from sticking to a hand during shaping. The lignin and glycerin above-cited as the organic additive give an appropriate level of water retentivity.

The organic additive also includes an anionic, cationic, nonionic, or any other surfactant (surface-active agent). The surfactant improves miscibility between the precious metal powder and the organic binder and improves water retentivity.

The organic binder and the organic additive which is added if necessary are used by dissolving in a solvent such as water, water/alcohol mixture, alcohol, and ester, etc. The amount of the solvent is determined in accordance with the intended use of the composition for precious metal sintering. If the ratio of the amount of the solvent to the total amount of the composition for precious metal sintering is low, the composition for precious metal sintering behaves like clay. If the ratio of an amount of the solvent to the total amount of the composition for precious metal sintering is high, the composition for precious metal sintering behaves like slurry or paste. Obviously, if the solvent amount is too little, the composition for precious metal sintering becomes hard and is difficult to be handled for shaping. If the solvent amount is too much, the composition for precious metal sintering cannot maintain its shape. In order to finally obtain a prescribed ratio of an amount of the solvent in the composition for precious metal sintering, the solvent may be added portionwisely in two or more installments, or the solvent may be added at one time after a previously-prepared mixture of the organic binder solution in a prescribed concentration is added to the precious metal powder.

If a paste-like composition for precious metal sintering is desired, oily (meth)acrylate ester copolymer, oily phthalate ester or the like may be used, which serves as both the organic binder and the solvent (that is, as the organic binder solution).

The organic binder solution containing the organic binder, the solvent, and the organic additive mixable with the solvent to be added where necessary is preferably used in a concentration from 1 to 20 wt % including the organic additive.

The precious metal powder, the above-mentioned organic binder solution, and an inorganic additive such as a sintering accelerator or an adhesiveness improver to be added where necessary, except for the hollow glass powder, compose a precious metal fundamental composition of the present invention.

In the precious metal fundamental composition, 0.02 to 3.0 wt %, of starch and 0.02 to 3.0 wt % of a water-soluble cellulose-based binder by the dry solids content excluding the solvent are more preferably used as the above-mentioned organic binder. In this case, the solvent preferably used is water.

The water-soluble cellulose-based binder gives plasticity as described above. The starch increases dry strength of the composition for precious metal sintering when dried. However, if the starch alone is used as the organic binder, the obtained object tends to crack easily when applied. Thus, the water-soluble cellulose-based binder is also used for solving the problem.

The starch in a 0.02 to 3.0 wt % by the dry solids content excluding water as the solvent is contained in the precious metal fundamental composition as described above. If an amount of the starch is less than 0.02 wt %, the dry strength tends to be insufficient when dried. If the amount of the starch is more than 3.0 wt %, the obtained object tends to easily crack when applied and its shrinkage ratio is increased. On the other hand, as described above, the water-soluble cellulose-based binder in 0.02 to 3.0 wt % by the dry solids content excluding water as the solvent is also contained in the precious metal fundamental composition, as described above. If an amount of the water-soluble cellulose-based binder is less than 0.02 wt %, its effect of giving plasticity is not sufficiently achieved. If the amount of the water-soluble cellulose-based binder is more than 3.0 wt %, the shrinkage ratio of the obtained object is increased. The water-soluble cellulose-based binder includes methylcellulose, hydroxyethylcellulose, hydroxypropylcellulose, and hydroxypropylmethylcellulose, etc, and is used by being dissolved in water as the solvent.

If the aforementioned starch and the water-soluble cellulose-based binder are used as the organic binder, the amount of the organic binder in the precious metal fundamental composition is preferably in the range of 0.1 to 4 wt % by the dry solids content excluding water as the solvent. In this case, if the amount of the organic binder is less than 0.1 wt %, it is difficult to obtain a homogeneous precious metal fundamental composition. Further, strength after application or drying becomes disadvantageously lowered. If the amount of the organic binder is more than 4 wt %, the shrinkage ratio of the obtained object is increased and the object tends to easily crack.

If polyethylene oxide is used, the polyethylene oxide preferably has a molecular weight from a hundred thousand to several millions and is used in an amount in the range of 0.1 to 3 wt %.

If a surfactant is used, surfactant in the range of 0.03 to 3 wt % is preferably used. If oil is used, oil in the range of 0.1 to 3 wt % is preferably used.

As a sintering accelerator, a powder of Bi, Se, Sb, In, Sn, and Zn or an alloy powder thereof may be added to the precious metal fundamental composition. Alternatively, at least one compound selected from the group of B₂O₃, SiO₂, and Li₂O may be added as a sintering accelerator. That is, at least one compound selected from the group of B oxide, Si oxide, and Li oxide may be contained in the precious metal fundamental composition as a sintering accelerator. Note that the hollow glass powder as a commercially-available product contains Si oxide or B oxide as described above, which is expected to effectively work as the sintering accelerator when sintering the precious metal powder.

Further, as the adhesiveness improver, a glass powder or a metallic compound powder selected from lead carbonate, lithium carbonate, zinc oxide, phosphoric acid, sodium carbonate, vanadium oxide, sodium silicate, phosphate salt, or the like may be added to the precious metal fundamental composition.

In addition to the above mentioned inorganic additives, a palladium (Pd) powder may be used as another inorganic additive. Herein, if a precious metal used is silver or silver alloy, a film of sulfide such as black-colored silver sulfide (Ag₂S) is formed by the reaction between a sulfur ion (S²⁻) and the silver at ambient temperature, which drastically decreases a decorative effect of the silver sintered product. Thus, in order to avoid such a drawback, a palladium (Pd) powder in the range of 0.05 to 1 wt % with respect to a pure silver (Ag) powder maybe added so as to provide the silver sintered product with a sulfurization resistant property.

Additional ratios of the respective components mentioned above in the composition for precious metal sintering are described hereinafter. Preferably, the composition for precious metal sintering comprises the precious metal fundamental composition comprised of 50 to 99 wt % of the precious metal powder, 1 to 50 wt % of the organic binder solution, and the hollow glass powder in the range of the following ratio. That is, a volume ratio of a bulk volume of the hollow glass powder is set in the range of 5 to 160% with respect to a total volume of the composition for precious metal sintering in which the bulk volume of the hollow glass powder being measured in a state where the hollow glass powder exists independently without any other components. In this case, the organic binder solution in the composition for precious metal sintering has a concentration equivalent in the range of 1 to 20 wt % of the composition thereof.

With the additional ratios of the respective components as described above, the composition for precious metal sintering can be handled similarly to a composition for precious metal sintering according to conventional technology without reducing ease of handling such as shapability, and, while maintaining a visual (aesthetic) value, can obtain a precious metal sinter having much less weight than a precious metal sinter according to the conventional technology.

“Bulk volume” refers to a volume measured in such a way of, for example, putting a hollow glass powder in a measuring cylinder and measuring its volume with a scale of the measuring cylinder. The bulk volume includes the volume of the powder itself as well as that of interspace between particles of the powder and between the particles and the inside wall surface of the measuring cylinder.

Therefore, the volume ratio of a bulk volume of the hollow glass powder in the range of 5 to 160% with respect to a total volume of the composition for precious metal sintering in which the bulk volume of the hollow glass powder is measured in a state where the hollow glass powder exists independently without any other components can be expressed by:

(a bulk volume of a hollow glass powder added/an actual volume of a total composition)×100=5 to 160%. The calculated result may exceed 100% because the “bulk volume” of the hollow glass powder added is used.

In general, two different powders having different particle sizes from each other (for example, a precious metal powder and a hollow glass powder) are mixed together, the bulk volume of the mixed powder is smaller than a sum of respective bulk volumes of the two different powders. This is because, in the mixed powder, a smaller particle of one powder is crammed between larger particles of the other, which increases the bulk density of the mixed powder. Thus, in the present invention, an actual volume of an entire composition corresponds to an actual volume of the composition for precious metal sintering in which at least the precious metal powder, the hollow glass powder, and the organic binder solution are mixed together. Since the bulk volume of the added hollow glass powder is compared to the above actual volume, the bulk volume may exceed 100%.

Such a definition on the actual volume as above-mentioned has been made because the bulk density of the precious metal powder or the hollow glass powder varies according to the shape or a state thereof, and even if either one of a wt % or a vol % is used in the explanation, the actual desired conditions of the present invention cannot be clearly shown.

As described above, the ratios of the respective components in the composition for precious metal sintering are preferable in which: the precious metal fundamental composition is included, comprised of 50 to 99 wt % of the precious metal powder and 1 to 50 wt % of the organic binder solution; and the hollow glass powder is included, set in a volume ratio of a bulk volume of the hollow glass powder in the range of 5 to 160% with respect to a total volume of the composition for precious metal sintering in which the bulk volume of the hollow glass powder is measured in a state where the hollow glass powder exists independently without any other components. In other words, the ratios are expressed as the composition for precious metal sintering having: 40 to 90 vol % of the precious metal fundamental composition with 50 to 99 wt % of the precious metal powder, 0.02 to 10 wt % of the organic binder, and the remainder of the solvent; and 10 to 60 vol % of the hollow glass powder.

An added amount of the hollow glass powder is preferably 10 vol % or more, especially if an effect obtained by reducing the amount of the precious metal powder with reduction in weight is compared to the cost of preparing a lightweight clay-like composition. On the other hand, if 60 volt or less of the hollow glass powder is included in the composition for precious metal sintering, the obtained object does not fracture or crack after sintering, for example, during polishing.

The ratios of the respective components in the composition for precious metal sintering greatly vary depending on the size, the shape, or the like of the precious metal powder and the hollow glass powder. Moreover, the ratios are not determined in a uniform way because the different types (in form of clay, slurry, paste, and the like) of a desired composition for precious metal sintering require different types, combinations, solvent quantities, or the like of the organic binder. As a result, the maximum measurement value of a pushing load is used as a comprehensive indicator of the obtained composition for precious metal sintering (for example, as an indicator for determining whether the obtained composition for precious metal sintering obtained as a finished product is good or poor). The maximum measurement value of the pushing load is measured in such a way that a syringe is filled with the composition for precious metal sintering, and a value of the maximum pushing load is measured when the composition for precious metal sintering is extruded from an outlet of the syringe.

The maximum measurement value of a syringe pushing load is influenced by the size, the shape, and the like of the precious metal powder and the hollow glass powder. Moreover, it is convenient that the maximum measurement value of a syringe pushing load varies according to a type, the combination, the water content, or the like of the organic binder, as well as the combination ratio of the precious metal powder, the hollow glass powder, and the organic binder solution. The maximum measurement value of a syringe pushing load can therefore be a comprehensive indicator of the composition for precious metal sintering.

Next are described a device for measuring a maximum value of a syringe pushing load and a method of measurement.

### (1) Measurement Device

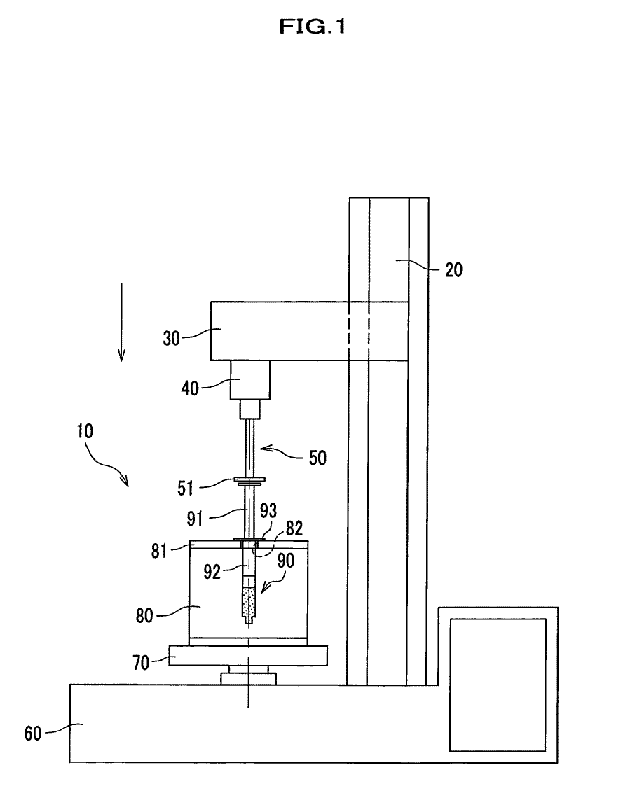

Herein, description is made taking a case as an example in which a testing device (manufactured by Shimadzu Corporation, a compact desk-sized testing machine EZ Test [EZ-S type]) shown in FIG. 1 is used as the syringe pushing load measurement device. A crosshead 30 is disposed in a vertically movable manner along a support post 20 of a measurement device body 10 at a desired constant speed.

An upper compression jig 50 is fixed to a lower portion of an end of the crosshead 30 via the lower end of a gauge head of a load cell 40. A disk-shaped plate 51 is disposed at a tip of the upper compression jig 50 such that the plate 51 can come in contact with and pushes down a plunger (piston) 91 of a syringe 90.

A support post base 60 is disposed at a base end lower portion of the support post 20 of the measurement device body 10. A lower stationary compression stand 70 is fixed on the support post base 60 below the upper compression jig 50. An H-section steel [H125 (H dimension)×125 (B dimension)] 80 is put on an upper surface of the lower stationary compression stand 70. A hole 82 is created in an upper flange 81 of the H-section steel 80. The hole 82 allows a barrel (external cylinder) 92 of the syringe 90 to penetrate but does not allow a flange 93 disposed on the barrel 92 to penetrate.

### (2) Method of Measurement

A 2-ml syringe [product name: JMS syringe 2-ml without needle (micro), manufactured by JMS Co., Ltd.] having an inner diameter of 6 mm, an outlet inner diameter of 1.3 mm, and an outlet inner length of 8.3 mm is filled with 1 ml of the composition for precious metal sintering to be measured. The syringe 90 is inserted from above into the hole 82 of the H-section steel 80 put on the lower stationary compression stand 70 of the measurement device body 10. The flange 93 of the syringe 90 is brought in contact with the upper flange 81 of the H-section steel 80, to thereby fix the syringe 90.

The crosshead 30 is moved downward along the support post 20 at a constant speed of 17 mm/minute until the plate 51 at a tip of the upper compression jig 50 presses down the plunger 91 of the syringe 90, to thereby extrude the composition for precious metal sintering from the outlet of the syringe 90. Values of pushing load during a period in which the plunger 91 of the syringe 90 travels 10 mm are recorded with a recorder (not shown) accompanying the device. The maximum value is extracted from the recorded measurement values.

If the maximum measurement value of the pushing load measured by the above measurement method is in the range of 0.08 to 1.13 N, the composition for precious metal sintering is good and is excellent in shapability.

Further, if the maximum measurement value of the pushing load measured by the above measurement method is in the range of 0.24 to 1.13 N, the composition for precious metal sintering has plasticity especially suitable for manual shaping like ordinary clay and is excellent in shapability.

Even further, if the maximum measurement value of the pushing load measured by the above measurement method is in the range of 0.08 to 0.23 N, the composition for precious metal sintering is suitable for representing a delicate line pattern. This is because the composition for precious metal sintering filled in a syringe, at the tip of which is set a fine nozzle, can be easily extruded in a filament shape or a string shape by manually pressing the plunger (piston) of the syringe.

Generally, a 10-ml syringe is preferably used in the shaping process. A fine nozzle attached to the syringe preferably has an inner diameter in the range of 0.4 to 1.2 mm.

When a clay-like composition is extruded from the syringe, it is needed to extrude a necessary amount of the clay-like composition at as constant a speed as possible. If the clay-like composition is extruded at a slow speed or is stopped halfway, the extruded portion thereof in such a state becomes thin and loses its aesthetic value.

The thinner the nozzle, the larger the resistance of extruding the clay-like composition from the syringe. Accordingly, if the clay-like composition is too hard, it is thus difficult to extrude the clay-like composition at a constant speed. Nonetheless, if a thin nozzle is used, the composition for precious metal sintering quickly gets dry because the surface area thereof is increased. Thus, even if the composition for precious metal sintering is softer than the ordinary one, the composition can maintain its form because the surface thereof becomes hard before the composition drips.

On the other hand, if the soft clay-like composition is used for drawing a thick line, the composition tends to quickly drip. Accordingly, for drawing a thick line, a hard clay-like composition is conveniently used because the resistance of extruding the clay-like composition from a syringe is reduced in case of the thick line.

A process for producing a precious metal sinter of the present invention includes the steps of: shaping the composition for precious metal sintering as described above; drying the shaped object; and sintering the dried shaped object to obtain the precious metal sinter.

The composition for precious metal sintering of the present invention can be shaped, dried, and sintered in a similar way to a process for producing a precious metal sinter according to the conventional technology, because the composition for precious metal sintering of the present invention does not lose ease of handling such as shapability. Accordingly, a precious metal sinter having much less weight can be obtained while maintaining a visual value thereof.

Thus, in the step of shaping the composition for precious metal sintering, the composition for precious metal sintering may be shaped arbitrarily using a hand or a jig such as a spatula, similar to a conventional composition for precious metal sintering (which does not include the hollow glass powder). Further, the composition for precious metal sintering may be mold-formed using a mold which may be modified from a generally-available mold. Furthermore, the composition for precious metal sintering may be shaped and mold-formed in a combination manner. For example, the composition for precious metal sintering is put in a mold. Then, the molded composition for precious metal sintering is removed from the mold to be further shaped using a hand, a jig, or the like.

The composition for precious metal sintering of the present invention may be dried and sintered in any suitable combination with a conventional composition for precious metal sintering including no hollow glass powder, a shaped object for precious metal sintering, a precious metal cast object, or the like. Specifically, the composition for precious metal sintering of the present invention may be prepared in combination with, for example, silver and gold, or platinum and gold, and then dried and sintered simultaneously or successively.

In the step of sintering the dried shaped object, the sintering temperature is adjusted in the range of 600 to 900° C. which is near the softening point of the hollow glass powder. This makes it possible to produce a lightweight precious metal sinter without using a special device or installations, similar to the process according to conventional technology.

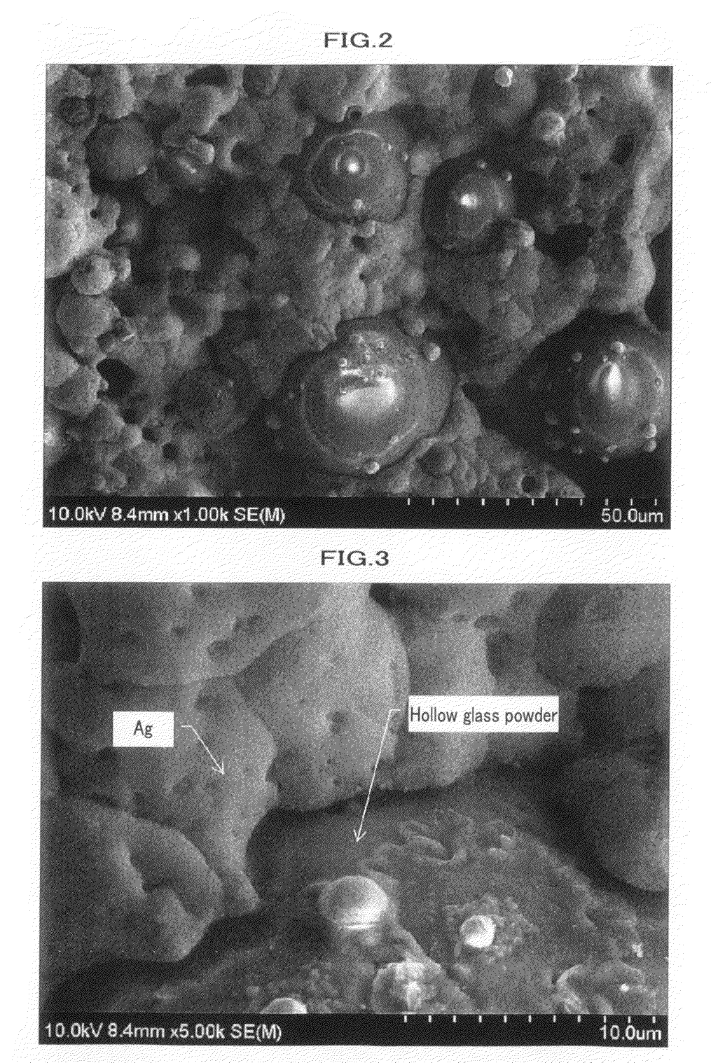

FIG. 2 and FIG. 3 show a SEM (Scanning Electron Microscope) image of a precious metal sinter of the present invention which is produced by sintering the composition for precious metal sintering (a composition for silver sintering) of the present invention having a composition shown in a top row of Table 2. The precious metal sinter is sintered in an electric furnace at 650° C. for 30 minutes.

In general, a formed object containing powder of a precious metal shrinks more than the bare metal thereof after sintered. The smaller the density of the powder, the larger the shrinkage. This means that a finished sinter may have a shape far from that of its original formed object.

However, as seen from the SEM image, when the composition for precious metal sintering (containing the hollow glass powder) of the present invention is used, the hollow glass powder maintains shape without melting under sintering conditions of 650° C. for 30 minutes, even though the density of the composition for precious metal sintering is small. Hereby, it can be understood that the hollow glass powder prevents the precious metal powder from shrinking in volume, which allows the precious metal sinter to maintain shape.

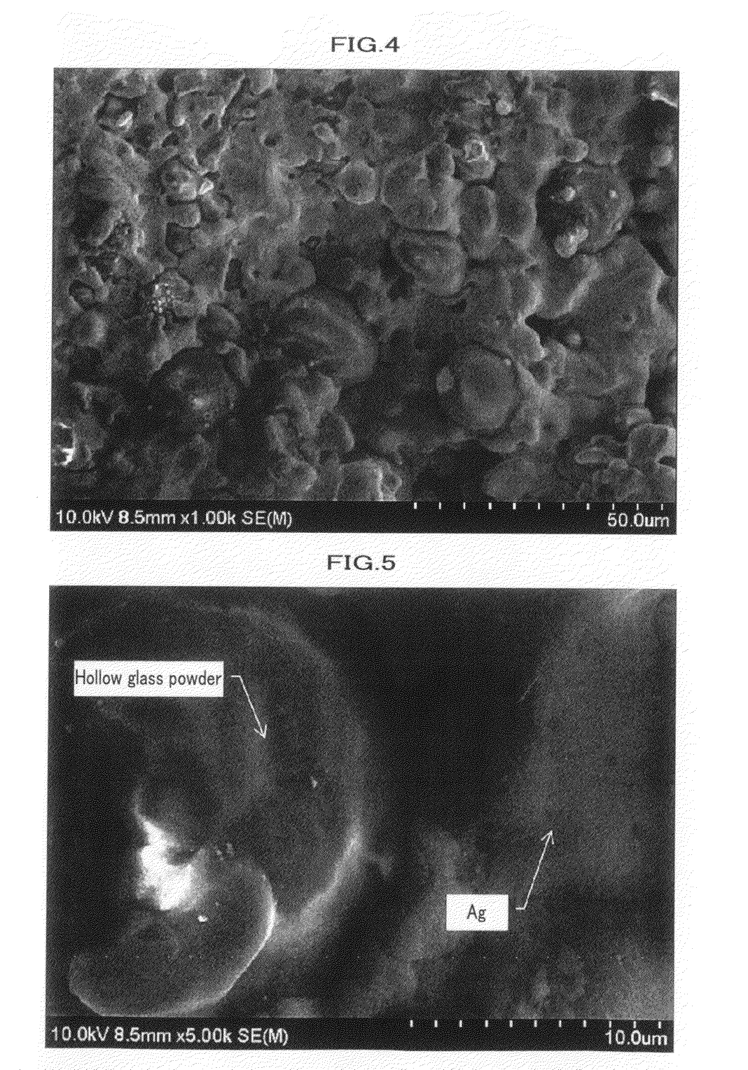

FIG. 4 and FIG. 5 show a SEM image of a precious metal sinter of the present invention which is produced by sintering the composition for precious metal sintering (a composition for silver sintering) of the present invention having the same composition as mentioned above and shown in the top row of Table 2. The sintering was conducted in an electric furnace at 800° C. for 30 minutes.

The SEM image demonstrates that the hollow glass powder is deformed but does not melt completely to maintain the shape to a certain degree, under the sintering conditions of 800° C. for 30 minutes. Hereby, it can be understood that the hollow glass powder prevents the precious metal powder from shrinking in volume and contributes to maintaining the shape of the sinter, even though the density of the composition for precious metal sintering is small.

The precious metal sinter of the present invention has a drastically reduced weight by mixing the hollow glass powder therein and maintains a visual value, similarly to a precious metal sinter according to the conventional technology.

That is, the precious metal sinter of the present invention appears similar to a conventional precious metal sinter including no hollow glass powder and is extremely light, because the precious metal sinter of the present invention has a structure in which the hollow glass powder is dispersed in the precious metal sinter. The precious metal sinter of the present invention is capable of obtaining the precious metallic luster thereof by being polished, similarly to the conventional precious metal sinter. Accordingly, the precious metal sinter of the present invention can be suitably used for accessories to be worn such as a pendant (head) and a brooch as well as glasses, metallic parts of a bag, and lightweight parts of a watch's belt, case, and parts on an hour plate.

Further, the precious metal sinter of the present invention can provide a more decorative effect by being subjected to surface treatment such as electroplating, electroless plating, a deposition film-formation treatment such as PVD and CVD, or the like. Herein, it is noted that the precious metal sinter of the present invention comprises an electrical insulating material on a portion of the surface thereof. Therefore, particularly if the surface treatment such as electro/electroless plating is performed for the precious metal sinter of the present invention, the plating treatment may be performed after conducting activator or sensitizer treatment (activation) that gives electrical conductivity to the surface of the precious metal sinter. Further, if the PVD/CVD treatment is performed, the precious metal sinter may be provided with an intermediate film so as to improve the adhesiveness thereof.

Further, it is also possible to enhance the decorative effect of the precious metal sinter by mixing hollow glass powder to which coloring treatment has been conducted, with a clay-like composition for precious metal sintering.

### Examples

### Example 1

A silver fundamental composition was prepared by mixing: 8 wt % of an organic binder solution consisting of 8.75 wt % of starch, 10 wt % of cellulose, and the remainder of water; and 92 wt % of a silver mixed powder consisting of 50 wt % of Ag powder having a mean particle diameter of 2.5 μm (46 wt % with respect to a total of the silver fundamental composition) and 50 wt % of Ag powder having a mean particle diameter of 20 μm (46 wt % with respect to the total of the silver fundamental composition).

With 99.8 g of the silver fundamental composition thus obtained was mixed 0.2 g of a hollow glass powder (equivalent to a bulk volume of 2.67 cm³ measured in a state where the hollow glass powder exists independently without any other components) (Glass Bubbles, manufactured by Sumitomo 3M Ltd.: a bulk density of 0.075 g/cm³, a real density of 0.125 g/cm³, and a particle size of 65 μm) to obtain a composition for silver sintering.

The density of the composition for silver sintering was calculated from the volume and the weight of the composition for silver sintering molded in a cube, to thereby obtain the result of 5.51 g/cm³.

Then, the composition for silver sintering was filled in a 2-ml syringe [product name: JMS syringe 2-ml without needle (micro), manufactured by JMS Co., Ltd.] having an inner diameter of 6 mm, an outlet inner diameter of 1.3 mm, and an outlet inner length of 8.3 mm to measure the value of the above-mentioned pushing load. The measurement value of the pushing load was 0.90 N.

Next, the composition for silver sintering was molded in a silicon mold having a prescribed volume and was sintered in an electric furnace under conditions shown in Table 1. Subsequently, the obtained sintered sample was barrel-polished and was evaluated as “good” or “poor” by determining whether or not the obtained sintered sample was broken with cracking, fracture, or the like. The evaluation results are also shown in Table 1.

Further, the weight of each composition for silver sintering filled in the silicon mold and the weight of each sinter obtained by sintering the composition for silver sintering are shown in Table 2. The sintering was conducted under conditions of 600° C. for 30 minutes. The results are shown in Table 3. Herein, each weight reduction rate described in Table 3 was calculated by the following equation:

Weight reduction rate=(Weight of silver sinter in Comparative Example 6−Weight of silver sinter in each Example)/Weight of silver sinter in Comparative Example 6.

TABLE 1

| Sintering | | | |
|---|---|---|---|
| Temperature | Time | | |
| (° C.) | (min.) | Evaluation | Results |
| 600 | 30 | good | Polishing obtained Metallic |
| 700 | 15 | good | luster. No cracking. 1.9% |
| 800 | 5 | good | weight reduction occurred, |
| | | | compared to the composition |
| | | | which added no hollow glass |
| | | | powder. |

### Examples 2 to 8

Examples 2 to 8 were conducted similarly to Example 1 as described above except that an added amount and a size of the hollow glass powder were changed as shown in Table 2, such that a bulk volume of the hollow glass powder was set in the range of 5 to 160% with respect to the entire composition. Sintering was conducted under conditions of 600° C. for 30 minutes. The results are shown in Table 2 and Table 3.

### Comparative Example 1

Comparative Example 1 was conducted similarly to Example 1 as described above except that an added amount and a size of the hollow glass powder were changed as shown in Table 2. Sintering was conducted under conditions of 600° C. for 30 minutes. Compositions of the formula for silver sintering and the results are shown in Table 2 and Table 3, respectively.

### Comparative Examples 2 and 3

Comparative Examples 2 and 3 were conducted similarly to Example 1 as described above except that, in Comparative Example 2, 1.3 g of, and, in Comparative Example 3, 0.1 g of plastic micro objects (product name: EXPANCEL [manufactured by Japan Fillite Co., Ltd.]) having a mean particle diameter of 50 μm and a bulk density of 0.02 g/cm³ was added respectively, to thereby each prepare 100 g in weight of the compositions for silver sintering. The plastic micro objects were used instead of the hollow glass powder. Sintering was conducted under conditions of 600° C. for 30 minutes. Obtained sinters in both Comparative Example 2 and Comparative Example 3 were deformed during sintering and were not successful. The compositions of the obtained formula for silver sintering and the results are shown in Table 2 and Table 3, respectively.

### Comparative Examples 4 and 5

Comparative Examples 4 and 5 were conducted similarly to Example 1 as described above except that, in Comparative Example 4, 15.8 g of, and, in Comparative Example 5, 1.4 g of, silica-based hollow micro spheres (product name: Fillite [manufactured by Japan Fillite Co., Ltd.]) having a mean particle diameter of 60 μm and a bulk density of 0.4 g/cm³ was added respectively, to thereby each prepare 100 g in weight of the composition for silver sintering. Here, the silica-based hollow micro spheres were used instead of the hollow glass powder. Sintering was conducted under conditions of 600° C. for 30 minutes. The results show that impurities were observed on the respective surfaces of the sinters in both Comparative Example 4 and Comparative Example 5 even after polishing the sinters, thereby failing to show the sufficient metallic luster. The compositions of the obtained compositions for silver sintering and the results are shown in Table 2 and Table 3, respectively.

### Comparative Example 6

Comparative Example 6 was conducted similarly to Example 1 under the conditions shown in Table 2, except that the hollow glass powder was not used. The sintering was conducted under conditions of 600° C. for 30 minutes. The compositions of the obtained formula for silver sintering and the results are shown in Table 2 and Table 3, respectively.

TABLE 2

| | Hollow Glass Powder | | | | | | | | | | |
|---|---|---|---|---|---|---|---|---|---|---|---|
| | (HGP) or Alternative | | | | | | | | | | |
| | (Comparative | | | | | Composition for Precious | | | | | |
| | Examples | | | | | Metal Sintering | | | | | |
| | (Com. Ex.) | | | | | (CPMS) | | | | | |
| | 2 to 5) | | | | | | | | Bulk | Weight | Weight of |
| | Mean | | | | Weight of | | | | Vol. of | of CPMS | Precious |
| | Particle | Bulk | Added | Bulk | Fundamental | Total | Total | Total | HGP/Total | used in | Metal |
| | Diameter | Density | Amount | Volume | Composition | Weight | Density | Volume | Volume | Mold | Sinter |
| | (μm) | (g/cm³) | (g) | (cm³) | (g) | (g) | (g/cm³) | (cm³) | (%) | (g) | (g) |
| SEM | 27 | 0.378 | 4.75 | 12.6 | 95.25 | 100 | 4.02 | 24.9 | 50.6 | 40.0 | |
| Image | | | | | | | | | | | |
| Example | 65 | 0.075 | 0.2 | 2.67 | 99.8 | 100 | 5.51 | 18.1 | 14.8 | 54.9 | 50.5 |
| (Ex.) 1 | | | | | | | | | | | |
| Ex. 2 | 65 | 0.075 | 2.8 | 37.3 | 97.2 | 100 | 4.10 | 24.4 | 153 | 40.8 | 35.6 |
| Ex. 3 | 55 | 0.155 | 0.5 | 3.23 | 99.5 | 100 | 5.38 | 18.6 | 17.4 | 53.6 | 49.3 |
| Ex. 4 | 55 | 0.155 | 6.3 | 40.6 | 93.7 | 100 | 2.55 | 39.2 | 104 | 25.4 | 23.5 |
| Ex. 5 | 40 | 0.285 | 0.5 | 1.75 | 99.5 | 100 | 5.32 | 18.8 | 9.3 | 53.0 | 48.8 |
| Ex. 6 | 40 | 0.285 | 12.1 | 42.5 | 87.9 | 100 | 2.39 | 41.8 | 102 | 23.8 | 22.1 |
| Ex. 7 | 27 | 0.378 | 0.5 | 1.32 | 99.5 | 100 | 5.39 | 18.6 | 7.1 | 53.7 | 49.4 |
| Ex. 8 | 27 | 0.378 | 14.9 | 39.4 | 85.1 | 100 | 2.5 | 40.0 | 98.5 | 24.9 | 23.2 |
| Ex. 9 | 27 | 0.378 | 5.4 | 14.3 | 94.6 | 100 | 3.5 | 28.6 | 50.0 | 34.9 | 31.6 |
| Com. | 65 | 0.075 | 4.8 | 64.0 | 95.2 | 100 | 3.05 | 32.8 | 195 | 30.4 | |
| Ex. 1 | | | | | | | | | | | |
| Com. | 50 | 0.02 | 1.3 | 65.0 | 98.7 | 100 | 2.3 | 43.5 | 149 | 22.9 | |
| Ex. 2 | | | | | | | | | | | |
| Com. | 50 | 0.02 | 0.1 | 5.0 | 99.9 | 100 | 5.06 | 19.8 | 25.3 | 50.4 | |
| Ex. 3 | | | | | | | | | | | |
| Com. | 60 | 0.4 | 15.8 | 39.5 | 84.2 | 100 | 2.66 | 37.6 | 105 | 26.5 | |
| Ex. 4 | | | | | | | | | | | |
| Com. | 60 | 0.4 | 1.4 | 3.5 | 98.6 | 100 | 5.12 | 19.5 | 17.9 | 51.0 | |
| Ex. 5 | | | | | | | | | | | |
| Com. | | | 0 | | 100 | 100 | 5.62 | 17.8 | 0 | 56 | 51.5 |
| Ex. 6 | | | | | | | | | | | |

TABLE 3

| | Evaluation | Results |
|---|---|---|
| Ex. 1 | good | Polishing obtained metallic luster. No |
| | | cracking occurred. 1.9% weight reduction |
| | | compared to the composition added no hollow |
| | | glass powder (Comparative Example 6). |
| Ex. 2 | good | Polishing obtained metallic luster. No |
| | | cracking. 27.0% weight reduction compared to |
| | | the composition added no hollow glass powder. |
| Ex. 3 | good | Polishing obtained metallic luster. No |
| | | cracking. 4.3% weight reduction compared to the |
| | | composition added no hollow glass powder. |
| Ex. 4 | good | Polishing obtained metallic luster. No |
| | | cracking. 54.4% weight reduction compared to |
| | | the composition added no hollow glass powder. |
| Ex. 5 | good | Polishing obtained metallic luster. No |
| | | cracking. 5.2% weight reduction compared to the |
| | | composition added no hollow glass powder. |
| Ex. 6 | good | Polishing obtained metallic luster. No |
| | | cracking. 57.1% weight reduction compared to |
| | | the composition added no hollow glass powder. |
| Ex. 7 | good | Polishing obtained metallic luster. No |
| | | cracking. 4.1% weight reduction compared to the |
| | | composition added no hollow glass powder. |
| Ex. 8 | good | Polishing obtained metallic luster. No |
| | | cracking. 55.0% weight reduction compared to |
| | | the composition added no hollow glass powder. |
| Com. | Poor | Satin finished surface sinter was obtained. |
| Ex. 1 | | Fractured during polishing. |
| Com. | Poor | Deformed during sintering. Failed to obtain |
| Ex. 2 | | good sinter. |
| Com. | Poor | Deformed during sintering. Failed to obtain |
| Ex. 3 | | good sinter. |
| Com. | Poor | Impurities were observed on sinter surface even |
| Ex. 4 | | after polishing. Failed to obtain sufficient |
| | | metallic luster. |
| Com. | Poor | Impurities were observed on sinter surface even |
| Ex. 5 | | after polishing. Failed to obtain sufficient |
| | | metallic luster. |

### Discussion on Examples 1 to 8 and Comparative Examples 1 to 6

As seen in Table 2, in Examples 1 to 8 of the present invention, the composition for silver sintering was prepared by using hollow glass powder having the bulk density in the range of 0.075 to 0.378 g/cm³ (a real density from 0.125 to 0.600 g/cm³) and adding hollow glass powder in an amount equivalent to a bulk volume thereof in the range of 7.1 to 153% with respect to a total volume of the composition for silver sintering including the hollow glass powder (that is, bulk volume of hollow glass powder/total volume of composition for silver sintering=7.1 to 153%) [which is equivalent to an added weight in the range of 0.2 to 14.9 wt %]. The above bulk volume of the hollow glass powder corresponds to a volume percentage thereof in the range of about 10% to about 60% in the composition for silver sintering.

The compositions for silver sintering of Examples 1 to 8 were each put in a mold of the same type and were sintered to obtain respective silver sinters. The silver sinters demonstrated the weight reduction effect from 1.9 to 57.1% in weight, compared to a silver sinter of Comparative Example 6 without using the hollow glass powder (see Table 3). Little difference was recognized in easiness in handling between the compositions for silver sintering of Examples 1 to 8 and that of Comparative Example 6 containing no hollow glass powder as in conventional technology. In contrast, defects were observed, as shown in Table 3, in the sinter of Comparative Example 1 to which an inappropriate (too much) amount of the hollow glass powder was added, and in the sinters of Comparative Examples 2 to 5 each of which did not use the hollow glass powder. Thus, calculation of weight reduction rates in the Comparative Examples 1 to 5 was decided to be skipped.

### Example 9

A gold fundamental composition was prepared by mixing: 8 wt % of an organic binder solution consisting of 8.75 wt % of starch, 10 wt % of cellulose, and the remainder of water; and 92 wt % of Au powder having a mean particle diameter of 4.5 μm.

With 94.6 g of the gold fundamental composition thus obtained was mixed 5.4 g of the hollow glass powder (Glass Bubbles, manufactured by Sumitomo 3M Ltd.: a bulk density of 0.378 g/cm³, a real density of 0.6 g/cm³, and a particle size of 27 μm) to obtain a composition for gold sintering.

Then, the composition for gold sintering was molded in a silicon mold and was sintered in an electric furnace under conditions of 800° C. for 30 minutes. The weight of the sinter thus obtained after the sintering was 31.6 g, resulting in a 40.0% weight reduction compared to a sinter having the same volume but added no hollow glass powder, which weighed 52.3 g. The results are also shown in Table 2.

Finally, the obtained sinter was barrel-polished, to thereby obtain a metallic luster thereof without causing cracking, fracture, or the like.

### Example 10

A silver fundamental composition was prepared by mixing: 8 wt % of an organic binder solution consisting of 5.25 wt % of starch, 10 wt % of cellulose, and the remainder of water; and 92 wt % of a silver mixed powder consisting of 50 wt % of Ag powder having a mean particle diameter of 2.5 μm (46 wt % with respect to a total of the silver fundamental composition) and 50 wt % of Ag powder having a mean particle diameter of 20 μm (46 wt % with respect to the total of the silver fundamental composition).

With 99.8 g of the silver fundamental composition thus obtained was mixed 0.2 g (a bulk volume of 2.67 cm³) of the hollow glass powder (Glass Bubbles, manufactured by Sumitomo 3M Ltd.: a bulk density of 0.075 g/cm³, a real density of 0.125 g/cm³, and a particle size of 65 μm) to obtain a composition for silver sintering (a total volume of 18.1 cm³). Herein, a ratio of the bulk volume of the added hollow glass powder assuming that the hollow glass powder exists independently was 14.7% with respect to the total volume of the composition for silver sintering.

Then, the composition for silver sintering was filled in a 2-ml syringe [product name: JMS syringe 2-ml without needle (micro), manufactured by JMS Co., Ltd.] having an inner diameter of 6 mm, an outlet inner diameter of 1.3 mm, and an outlet inner length of 8.3 mm to measure a value of the above-mentioned pushing load. The measurement value was 0.24 N.

A tip of another unused 2-ml syringe was cut to have indentation. The syringe was filled with the composition for silver sintering and then was pushed to extrude the composition for silver sintering. To make use of lines (or texture) drawn on the extruded bar-shaped composition for silver sintering, both ends of the bar composition were twisted to finally form a ring. The ring was put in a drying oven, and was dried at 80° C. for 20 minutes. Subsequently, the ring was sintered in an electric furnace at 600° C. for 30 minutes, and was finished with a stainless-steel brush and a polishing spatula, to thereby bring about a metallic luster.

As a result, flowing lines were formed on the surface of the ring, thereby obtaining a ring with excellent decorative performance.

### Example 11

In Example 11, a ring was created similarly to Example 10 but was left in the drying step

A silver fundamental composition was prepared by mixing: 13.5 wt % of an organic binder solution consisting of 5.25 wt % of starch, 6 wt % of cellulose, and the remainder of water; and 86.5 wt % of a silver mixed powder consisting of 50 wt % of Ag powder having a mean particle diameter of 2.5 μm (43.25 wt % with respect to a total of the silver fundamental composition) and 50 wt % of Ag powder having a mean particle diameter of 20 μm (43.25 wt % with respect to the total of the silver fundamental composition).

With 99.8 g of the silver fundamental composition thus obtained was mixed 0.2 g (a bulk volume of 2.67 cm³) of the hollow glass powder (Glass Bubbles, manufactured by Sumitomo 3M Ltd.: a bulk density of 0.075 g/cm³, a real density of 0.125 g/cm³, and a particle size of 65 μm) to obtain a composition for silver sintering (a total volume of 25.3 cm³). Herein, a ratio of the bulk volume of the added hollow glass powder assuming that the hollow glass powder exists independently was 10.5% with respect to the total volume of the composition for silver sintering.

Then, the composition for silver sintering was filled in a 2-ml syringe [product name: JMS syringe 2-ml without needle (micro), manufactured by JMS Co., Ltd.] having an inner diameter of 6 mm, an outlet inner diameter of 1.3 mm, and an outlet inner length of 8.3 mm to measure a value of the above-mentioned pushing load. The measurement value was 0.08 N.

Further, the composition for silver sintering was filled in another 10-ml syringe. Then, the syringe was equipped with a resin nozzle (having an inner diameter of 0.84 mm) at the tip thereof. The composition for silver sintering was excluded from the syringe to arrange an initial pattern on a surface of the above-mentioned ring left after the drying step.

The ring thus obtained was put in a drying oven, dried at 80° C. for 20 minutes, and sintered in an electric furnace at 600° C. for 30 minutes. The ring was then finished with a stainless-steel brush and a polishing palette, to thereby bring about a metallic luster.

Accordingly, an original three dimensional pattern was added to the surface of the ring, resulting in obtaining a ring with excellent decorative performance.

### Comparative Example 7

In Comparative Example 7, a ring was created similarly to Example 10 but was left in the drying step.

A silver fundamental composition was prepared by mixing: 20 wt % of an organic binder solution consisting of 3 wt % of starch, 4 wt % of cellulose, and the remainder of water; and a 80 wt % of a silver mixed powder consisting of 50 wt % of Ag powder having a mean particle diameter of 2.5 μm (40 wt % with respect to a total of the silver fundamental composition) and 50 wt % of Ag powder having a mean particle diameter of 20 μm (40 wt % with respect to the total of the silver fundamental composition).

With 99.8 g of the silver fundamental composition thus obtained was mixed 0.2 g (a bulk volume of 2.67 cm³) of the hollow glass powder (Glass Bubbles, manufactured by Sumitomo 3M Ltd.: a bulk density of 0.075 g/cm³, a real density of 0.125 g/cm³, and a particle size of 65 μm) to obtain a composition for silver sintering (a total volume of 31.2 cm³). Herein, a ratio of the bulk volume of the added hollow glass powder assuming that the hollow glass powder exists independently was 8.6% with respect to the total volume of the composition for silver sintering.

Then, the composition for silver sintering was filled in a 2-ml syringe [product name: JMS syringe 2-ml without needle (micro), manufactured by JMS Co., Ltd.] having an inner diameter of 6 mm, an outlet inner diameter of 1.3 mm, and an outlet inner length of 8.3 mm to measure a value of the above-mentioned pushing load. The measurement value was 0.05 N.

Then, the syringe was equipped with a resin nozzle (having an inner diameter of 0.84 mm) at a tip thereof. The composition for silver sintering was excluded from the syringe to arrange an initial pattern on the surface of the above-mentioned ring left after the drying step.

The ring thus obtained was put in a drying oven and was dried at 80° C. for 20 minutes. Hereby, a portion of the lines in the initial pattern additionally arranged on the surface of the ring ran off before dried and solidified, making it impossible for the lines to be read as initials.

### Comparative Example 8

A silver fundamental composition was prepared by mixing: 8 wt % of an organic binder solution consisting of 10 wt % of starch, 8.75 wt % of cellulose, and the remainder of water; and 92 wt % of a silver mixed powder consisting of 50 wt % of Ag powder having a mean particle diameter of 2.5 μm (46 wt % with respect to a total of the silver fundamental composition) and 50 wt % of Ag powder having a mean particle diameter of 20 μm (46 wt % with respect to the total of the silver fundamental composition).

With 99.8 g of the silver fundamental composition thus obtained was mixed 0.2 g (a bulk volume of 2.67 cm³) of the hollow glass powder (Glass Bubbles, manufactured by Sumitomo 3M Ltd.: a bulk density of 0.075 g/cm³, a real density of 0.125 g/cm³, and a particle size of 65 μm) to obtain a composition for silver sintering (a total volume of 18.1 cm³). Herein, a ratio of the bulk volume of the added hollow glass powder assuming that the hollow glass powder exists independently was 14.7% with respect to the total volume of the composition for silver sintering.

Then, the composition for silver sintering was filled in a 2-ml syringe [product name: JMS syringe 2-ml without needle (micro), manufactured by JMS Co., Ltd.] having an inner diameter of 6 mm, an outlet inner diameter of 1.3 mm, and an outlet inner length of 8.3 mm to measure a value of the above-mentioned pushing load. The measurement value was 1.5 N.

Subsequently, the composition for silver sintering was manually shaped in a bar-like form. When both ends of the bar-like composition were pulled to each other so as to form a ring, the bar-like composition was too hard to be bent and was finally broken.

1. A composition for precious metal sintering, comprising: a precious metal powder; an organic binder solution; and a hollow glass powder, and being suitable for manual shaping,
the composition for precious metal sintering having a volume ratio of a bulk volume of the hollow glass powder in the range of 5 to 160% with respect to a total volume of the composition for precious metal sintering, the bulk volume of the hollow glass powder being measured in a state where the hollow glass powder exists independently without any other components.

2. A composition for precious metal sintering, comprising: a precious metal fundamental composition including 50 to 99 wt % of a precious metal powder and 1 to 50 wt % of an organic binder solution; and a hollow glass powder, the composition for precious metal sintering being suitable for manual shaping,
the composition for precious metal sintering having a volume ratio of a bulk volume of the hollow glass powder in the range of 5 to 160% with respect to a total volume of the composition for precious metal sintering, the bulk volume of the hollow glass powder being measured in a state where the hollow glass powder exists independently without any other components.

3. The composition for precious metal sintering suitable for manual shaping as claimed in claim 1 or 2,
the hollow glass powder having a mean particle diameter from 15 to 65 μm, and
the precious metal powder having a mean particle diameter from 1.0 to 20 μm.

4. The composition for precious metal sintering suitable for manual shaping as claimed in claim 1 or 2,
a maximum measurement value of a pushing load being from 0.08 to 1.13 N, if measured by: filling a 2-ml syringe having an inner diameter of 6 mm, an outlet inner diameter of 1.3 mm, and an outlet inner length of 8.3 mm with 1 ml of the composition for precious metal sintering; pushing a plunger of the syringe 10 mm at a speed of 17 mm/minute; and extruding the composition for precious metal sintering from an outlet of the syringe.

5. The composition for precious metal sintering suitable for manual shaping as claimed in claim 4,
the composition for precious metal sintering, if having a clay-like plasticity, the maximum measurement value of the syringe pushing load being from 0.24 to 1.13 N.

6. The composition for precious metal sintering suitable for manual shaping as claimed in claim 4,
the composition for precious metal sintering, if shaped by being extruded from a syringe to make a three dimensional shape, having the maximum measurement value of the syringe pushing load of from 0.08 to 0.23 N when the composition for precious metal sintering within the syringe is extruded.

7. A process for producing a precious metal sinter, comprising the steps of:
shaping the composition for precious metal sintering as claimed in claim 1 or 2;
drying the shaped object; and
sintering the dried shaped object.

8. A precious metal sinter produced by the process as claimed in claim 7
